(19) United States
(12) Patent Application Publication
(10) Pub. No.: US 2008/0100815 A1
(43) Pub. Date: May 1, 2008

(54) ARRANGEMENT OF TWO CONNECTED BODIES

(75) Inventors: Hubert Holderer, Oberkochen (DE); Claudia Ekstein, Ellwangen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/842,313

(22) Filed: Aug. 21, 2007

(30) Foreign Application Priority Data
Aug. 21, 2006 (DE) 10 2006 038 992.1

(51) Int. Cl. G03B 27/54; B23P 11/00

(52) U.S. Cl. 355/67; 29/428

(57) ABSTRACT

Arrangements of a first body and a second body connected to the first body, as well as related systems and methods, are disclosed. The arrangements, systems and methods can be used, for example, with optical devices, such as in the field of microlithography systems used to manufacture of microelectronic devices.

### CROSS-REFERENCE TO RELATED APPLICATION

This application claims priority under 35 U.S.C. §119 to German Patent Application Serial Number 10 2006 038 992.1, filed Aug. 21, 2006, which is hereby incorporated by reference.

### FIELD

The present disclosure relates to arrangements of a first body and a second body connected to the first body, as well as related systems and methods. The arrangements, systems and methods can be used, for example, with optical devices, such as in the field of microlithography systems used to manufacture of microelectronic devices.

### BACKGROUND

It can be desirable in microlithography to maintain a pre-determined relative position of the components of the imaging device (e.g., the optical elements such as lenses, mirrors or grids) with respect to the wafer on which the microelectronic circuits are produced.

### SUMMARY

In one aspect, the disclosure generally provides an arrangement that includes a first body having a first contact surface, a second body having a second contact surface, and a material connected to the first and second contact surfaces at a joining location. At least one surface selected from the first contact surface and the second contact surface is divided into a plurality of partial contact surfaces that are at least partly separated from each other. A surface area of each of the partial contact surfaces is less than 15% of a total surface area of the joining location. The arrangement can be used, for example, in a microlithography system that includes an optical device.

In another aspect, the disclosure generally provides a method that includes connecting a first contact surface of a first body with a second contact surface of a second body via a material at a joining location. At least one surface selected from the first contact surface and the second contact surface being divided into a plurality of partial contact surfaces that are at least partly separated from each other. A surface area of each of the partial contact surfaces being less than 15% of a total surface area of the joining location. The arrangement can be used, for example, in the preparation of a microlithography system that includes an optical device.

In a further aspect, the disclosure generally provides a first body having a first contact surface, and a second body having a second contact surface. The first and second contact surfaces are connected to the first body at a joining location. A contact surface selected from the first contact surface and the second contact surface is divided into a plurality of partial contact surfaces that are at least partly separated from each other. A surface area of each of the partial contact surfaces is less than 15% of a total surface area of the joining location. The arrangement can be used, for example, in a microlithography system that includes an optical device.

In some embodiments, the disclosure can provide an arrangement of two connected bodies and/or a method for connecting two bodies, which can (e.g., in a simple manner) allow relatively high (e.g., maximum) stability of the geometry of the two bodies (e.g., even with pressure fluctuations).

The present disclosure recognizes that a reduction of gas inclusions between the contact surfaces can enhance geometrical stability in the case of pressure fluctuations if at least one of the contact surfaces is divided into a plurality of partial contact surfaces that are at least partly separated from each other so that the surface area of the respective partial contact surface is less than 15% of the total surface area of the joining location. This can allow for relatively small partial contact surfaces that can provide reduced gas inclusions between the contact surfaces.

It is believed that the comparatively small partial surface area (within which a connection between the two bodies takes place) results in a relatively short distance for gases to escape from the respective joining region between the contact surfaces into the gaps separating the partial contact surfaces, so that the probability of gas inclusions forming is substantially reduced. Relative to the total volume of the two bodies, fewer or smaller gas inclusions can develop as a result, which can lead to lesser deformations with pressure fluctuations in the surrounding atmosphere.

In some embodiments, the disclosure provide an arrangement of a first body and a second body connected to the first body in the region of a joining location, wherein the first body has a first contact surface and the second body has a second contact surface and the first body and the second body are connected to one another in the region of their contact surfaces. At least one of the contact surfaces in the region of the joining location is divided into a plurality of partial contact surfaces, at least partly separated from each other, wherein the surface area of the respective partial contact surface amounts to less than 15% of the total surface area of the joining location. The connection between the first body and the second body can include a material connection (e.g., an inorganic material connection).

In certain embodiments, the disclosure provides a method for connecting two bodies in the region of a joining location, wherein a first body with a first contact surface is made available, a second body with a second contact surface is made available and the first body and the second body are connected together in the region of their contact surfaces. At least one of the contact surfaces in the region of the joining location is divided into a plurality of partial contact surfaces, at least partly separated from each other, wherein the surface area of the respective partial contact surface amounts to less than 15% of the total surface area of the joining location.

Here, if desired, both contact surfaces can be divided accordingly into partial contact surfaces. Manufacturing, however, can be substantially simplified, if the partitioning is only carried out for one of the two contact surfaces. The other contact surface can then be formed in the known way simply as an at least generally coherent surface.

The partitioning of the contact surface concerned into the partial contact surfaces, at least partly separated from each other, can take place by any suitable mechanism. Thus, suitable recesses, such as grooves, slots or the like, which produce the separation, can be provided in the body concerned. Likewise, however, for producing the separation only one surface structure, deviating correspondingly widely from the surface of the partial contact surfaces, an accordingly heavily roughened surface for example, can also be provided.

Features and advantages of the invention are in the description, drawings and claims.

### BRIEF DESCRIPTION OF THE DRAWINGS

FIG. 1 is a schematic partial sectional view (along line I-I from FIG. 2) through an arrangement.

FIG. 2 is a schematic partial sectional view through the arrangement from FIG. 1 along line II-II from FIG. 1.

FIG. 3 is a schematic partial sectional view through an arrangement.

### DETAILED DESCRIPTION

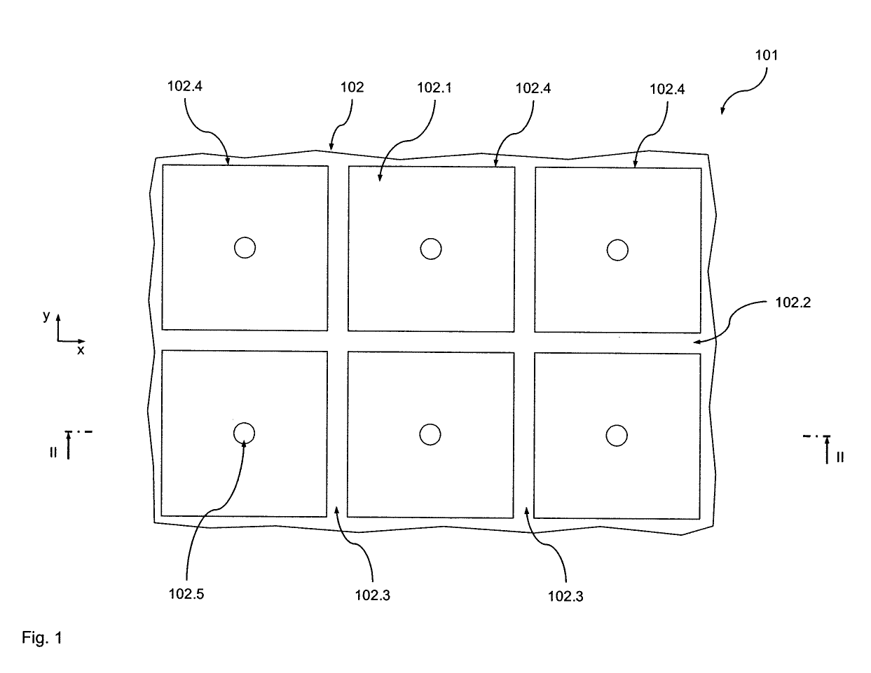

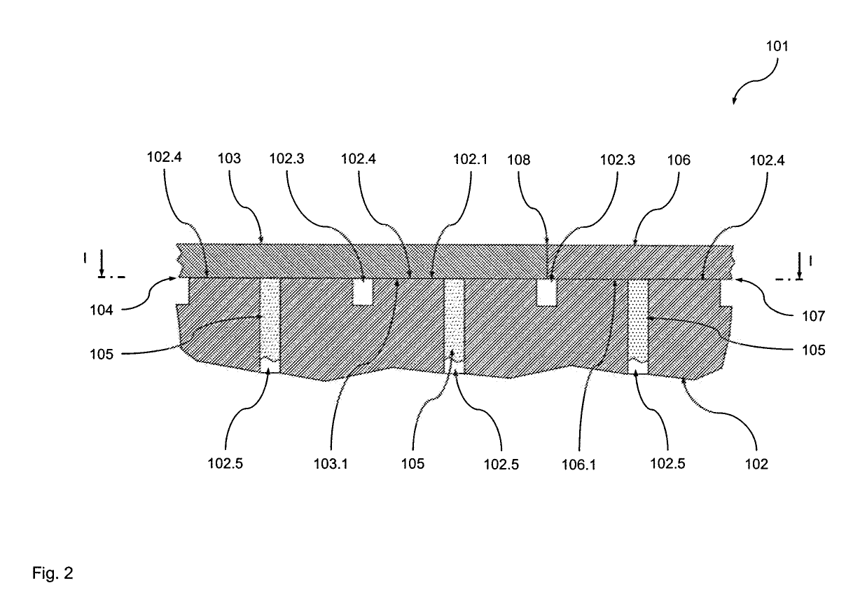

FIGS. 1 and 2 show an arrangement 101, which is used as a component of an encoder system in an optical imaging device for microlithography. The arrangement 101 includes a first body in the form of a carrying structure 102 and a second body in the form of a grid element 103, which are connected together in the region of a first joining location 104 by an optical contacting connection. The grid element 103, on its side facing away from the carrying structure 102, has an optical grid, which serves as a reference for the encoder system.

The carrying structure 102, on its side facing the grid element 103, has a first contact surface 102.1 in the region of the joining location 104. Likewise, the grid element 103 in the region of the joining location 104, on its side facing the carrying structure 102, has a second contact surface 103.1. The two contact surfaces 102.1 and 103.1 in a suitable way are correspondingly precisely implemented, so that when they make reciprocal contact an optical contacting connection is obtained in the commonly known way.

The first contact surface 102.1, in a grid-like manner, is divided into a plurality of partial contact surfaces 102.4, completely separated from each other by depressions or recesses 102.2 of the carrying structure 102 running in x-direction and by depressions or recesses 102.3 of the carrying structure 102 running in y-direction. In the present example, the recesses 102.2, 102.3 are arranged in a grid-like manner such that the partial contact surfaces 102.4 have a substantially square outer contour. Therefore, a kind of checkerboard pattern arises.

Because of their straight-line arrangement, the recesses 102.2, 102.3 and thus the carrying structure 102 can be produced relatively simply. However, in general, any partitioning of the first contact surface can take place in partial contact surfaces with any other polygonal or curved outer contour. Furthermore, if desired, only the recesses 102.2 or only the recesses 102.3 can be provided. Individual partial contact surfaces, such as partial contact surfaces in the boundary region of the first contact surface, can be partly connected to one another.

In contrast to this, the second contact surface 103.1 is designed as a substantially even, coherent surface area. As a result, manufacturing of the grid element 103 is simplified. Alternatively or additionally, the second contact surface in a suitable way is divided into corresponding partial contact surfaces.

The surface area of the respective partial contact surface 102.4 amounts to nearly 2% of the total surface area of the joining location 104 in each case. As a result of this comparatively small contact area between the respective partial contact surface 102.4 and the second contact surface 103.1, it is ensured that when the optical contacting connection between the carrying structure 102 and the grid element 103 is produced, only comparatively few or small gas inclusions develop between the respective partial contact surface 102.4 and the second contact surface 103.1.

It is believed that this is due, among other things, to the fact that the gas of the atmosphere, which surrounds the two bodies 102, 103 when they are joined, owing to the small contact area can escape over a relatively short distance from the region between the respective partial contact surface 102.4 and the second contact surface 103.1 into an adjacent recess 102.2, 102.3.

This can allow for relatively little inclusion of gas between the contact surfaces 102.1, 103.1 is possible. This can advantageously result in a reduction in the deformations of the grid element 103, which are caused by pressure fluctuations in the atmosphere surrounding the arrangement 101. Deformations, which result from heating of the arrangement 101 and thus from a thermally-induced increase in the pressure in the gas inclusions, can also reduced.

In some embodiments, the surface area of the respective partial contact surface amounts to less than about 15% (e.g., less than 5%) of the total surface area of the joining location between the two bodies.

The recesses 102.2, 102.3, as mentioned, can be produced relatively simply. Optionally, provision can also be made that the separation of the partial contact surfaces does not need to be achieved by such recesses intruding relatively deeply into a body. It is also possible that this separation is achieved by a corresponding surface structure, for example an accordingly heavily roughened surface, which still allows the gas to escape.

As is further evident from FIGS. 1 and 2, the carrying structure 102 for each partial contact surface 102.4 includes a channel in the form of a through-hole 102.5. Optionally, provision can also be made that only a fraction of the partial contact surfaces is provided with a corresponding channel leading to the partial contact surface.

Through this channel 102.5, a suitable adhesive 105 can be fed into the region of the joining location 104, after the optical contacting connection between the carrying structure 102 and the grid element 103 has been produced, so that the adhesive 105, on the one hand, contacts the carrying structure 102 in the channel 102.5 and, on the other hand, in the mouth region of the channel 102.5, also contacts the second contact surface 103.1, that is to say the grid element 103. The adhesive 105 can thus serve to reinforce the optical contacting connection, for example against high forces of inertia, as they occur during high accelerations (e.g., in the case of impacts). Due to its shrinkage, the adhesive 105 can also serve to increase the contacting force between the grid element 103 and the carrying structure 102. If desired, an inorganic material (e.g. a solder material etc.) may be used instead of the adhesive 105.

Furthermore, provision can also be made that all or part of the channels leading to the partial contact surfaces can be provided not in the body having the partial contact surfaces but in the other body.

As is also evident from FIG. 2, the arrangement 101 includes a third body in the form of a second grid element 106. This second grid element 106 is identical to the first grid element 103 so that reference is made in this respect to the corresponding explanations given above.

The second grid element 106 is connected in the same way as the first grid element 103 to the carrying structure 102 in the region of a second joining location 107. For this purpose, it has a third contact surface 106.1, which is connected by an optical contacting connection to the first contact surface 102.1 of the carrying structure 102.

The first grid element 103 and the second grid element 106 have joining surfaces facing each other, which contact one another in the region of a joint 108. The two grid elements 103, 106 are connected together in the region of the joint 108. In the present case, they are connected together in the region of the joint 108 by an optical contacting connection. However, any other suitable connection can also be selected. The two grid elements can be glued together.

The arrangement 101 can include yet further grid elements, so that a comparatively large optical grid poorly susceptible to deformation can be produced in a simple manner. In this case, it is possible, for example, to produce large optical grids, whose surface area lies in the region of 1 m² and beyond from still comparatively easy to produce grid elements, whose surface area lies in the region of 0.1 m².

The carrying structure 102 and the grid element 103 in the present example are made from a material of the same type. This has the advantage that the first coefficient of thermal expansion of the material of the carrying structure 102, if at all, only differs by a very small amount from the second coefficient of thermal expansion of the material of the grid element 103.

Therefore, the coefficients of thermal expansion of the carrying structure 102 and the grid element 103 are well-matched to one another. This can result in relatively little stress as possible occurs between the carrying structure 102 and the grid element 103 due to differing thermal expansion. However, combinations of different materials can also be used.

The risk of such thermally induced stress can be further reduced, due to the fact that the material of the carrying structure 102 and the grid element 103 has a relatively low coefficient of thermal expansion. Suitable materials here are glass ceramics, Zerodur, ULE or Clearceram, Cordierite or Invar or the like.

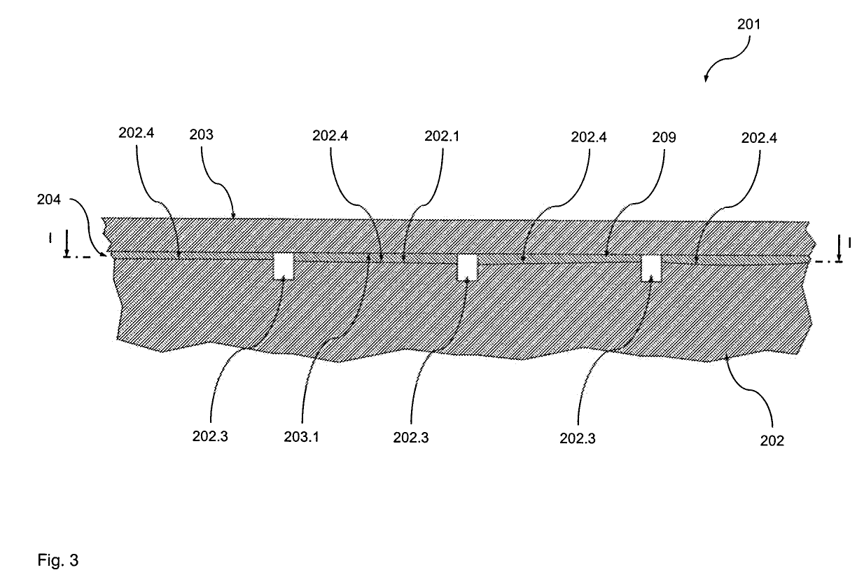

FIGS. 1 and 3 show an 201, which is used as a component of an encoder system in an optical imaging device for microlithography. The arrangement 201 includes a first body in the form of a carrying structure 202 and a second body in the form of a grid element 203, which are connected together in the region of a first joining location 204 by an inorganic material connection in the form of a solder joint. The grid element 203 is built like the grid element 103 in FIGS. 1 and 2, that is to say, on its side facing away from the carrying structure 202, it has an optical grid, which serves as a reference for the encoder system.

The carrying structure 202 likewise is generally similar to the carrying structure 102 in FIGS. 1 and 2. Only the channels 102.5 of the carrying structure 102 are missing from the carrying structure 202. The location of the section shown in FIG. 3 corresponds to the one of the section along line II-II in FIG. 1.

The carrying structure 202 is designed similarly to the carrying structure 102 in FIGS. 1 and 2, i.e. in the region of the joining location 204, on its side facing the grid element 203, it has a first contact surface 202.1. Likewise, in the region of the joining location 204, the grid element 203, on its side facing the carrying structure 202, has a second contact surface 203.1.

The two contact surfaces 202.1 and 203.1 in a suitable way are implemented with sufficient precision, so that between them a solder join can be obtained in the commonly known way as disclosed, for example, by EP 0 901 992 B1 (Holderer et al.) the entire disclosure of which is incorporated herein by reference. In order to connect the carrying structure 202 and the grid element 203, a film or layer of an additional material in the form of soldering metal 209 is applied between the two contact surfaces 202.1 and 203.1 in the commonly known way.

Like the first contact surface 102.1 in FIG. 1, the first contact surface 202.1 in a grid-like manner is divided into a plurality of partial contact surfaces 202.4 completely separated from each other by depressions or recesses of the carrying structure 202 running in x-direction and by depressions or recesses 202.3 of the carrying structure 202 running in y-direction. In the present example, the recesses 202.2, 202.3 are again arranged in a grid-like manner such that the partial contact surfaces 202.4 have a substantially square outer contour. Therefore, a kind of checkerboard pattern also arises here.

However, in general, any partitioning of the first contact surface can take place in partial contact surfaces with any other polygonal or curved outer contour.

In contrast to this, the second contact surface 203.1 is again formed as a substantially even, coherent surface area. As a result, manufacturing of the grid element 203 is simplified. However, it can be also provided that, alternatively or additionally, the second contact surface is divided into corresponding partial contact surfaces in a suitable way.

In the present example, the surface area of the individual partial contact surface 202.4 amounts to nearly 2% of the total surface area of the joining location 204 in each case. Due to this comparatively small contact area between the respective partial contact surface 202.4 and the soldering metal 209, it is ensured that when the solder join between the carrying structure 202 and the grid element 203 is produced, only comparatively few or small gas inclusions develop between the respective partial contact surface 202.4, the soldering metal 209 and the second contact surface 203.1.

This is due ultimately, among other things, to the fact that the gas of the atmosphere, which surrounds the two bodies 202, 203 when they are joined, owing to the small contact area, can escape over a relatively short distance from the region between the respective partial contact surface 202.4, the soldering metal 209 and the second contact surface 203.1 into an adjacent recess 202.2, 202.3.

In comparison to the known joining process, wherein comparatively large coherent contact surfaces are used, in this case substantial reduction of such gas inclusions between the contact surfaces 202.1, 203.1 is possible. In an advantageous way, this causes a reduction in the deformations of the grid element 203, which are caused by pressure fluctuations in the atmosphere surrounding the arrangement 201. Deformations, which result from heating of the arrangement 201 and thus from a thermally induced increase in the pressure in the gas inclusions, are also reduced.

In some embodiments, an additional joining material (e.g., soldering metal 209) can be present. If the surface area of the respective partial contact surface amounts to less than about 15% (e.g. less than 5%) of the total surface area of the joining location between the two bodies.

The recesses for separating the partial contact surfaces 202.4, as mentioned, can be produced relatively simply. As, however, it has likewise already been mentioned, provision can be made that the separation of the partial contact surfaces also with this joining method with an additional material does not need to be achieved by such recesses intruding relatively deeply into a body. By contrast, it is also possible that this separation is achieved by a suitable surface structure, for example an accordingly heavily roughened surface, which still allows the gas to escape.

A further advantage of the connection using an additional material, such as soldering metal 209, lies in the fact that the additional material can be suitable for levelling out manufacturing tolerances (e.g., geometry and/or position tolerances) of one or both contact surfaces 202.1, 203.1, as they are shown heavily exaggerated for the first contact surface 202.1 in FIG. 3, as the result of a varying layer thickness. It is possible in an advantageous way to even out co-planarity deviations of the partial contact surfaces 202.4.

It is also possible that the grid element 203, when it is joined, floats on the additional material, here the soldering metal 209, and can be connected virtually without stresses to the carrying structure 202.

In FIG. 3, the soldering metal layer 209 with regard to its actual shape in the region of the recesses 202.3, is only illustrated in a highly simplified manner and as an intermittent, that is to say, interrupted layer. However, in some embodiments (e.g., as a function of the characteristics of the soldering metal and the contact surfaces) a continuous layer of solder, which bridges the recesses, can also be provided.

Also, further grid elements can be connected to the carrying structure 202, in order to form a large optical grid in conjunction with the grid element 203. In this case, the grid elements in turn can be connected together in the region of their joint in a corresponding way. They can also be connected via the additional material already used anyway.

Here, it is thus also possible, for example, to produce large optical grids whose surface area lies in the region of 1 m² and beyond from comparatively easy to produce grid elements, whose surface area lies in the region of 0.1 m².

In place of the solder joint another material connection technique using an additional material (e.g., an inorganic connecting material) can also be selected. This includes so-called low temperature bonding connections, anodic bonding connections and fusion bonding connections etc.

The carrying structure 202 and the grid element 203 in the present example in turn are made from a material of the same type. This has the advantage that the first coefficient of thermal expansion of the material of the carrying structure 202, if at all, only differs by a very small amount from the second coefficient of thermal expansion of the material of the grid element 203.

Therefore, the coefficients of thermal expansion of the carrying structure 202 and the grid element 203 are well-matched to one another. This has the advantage that as little stress as possible arises between the carrying structure 202 and the grid element 203 due to the differing thermal expansion. However, different materials can also be used.

The risk of such thermally induced stress is further reduced, due to the fact that the material of the carrying structure 202 and the grid element 203 has a relatively low coefficient of thermal expansion. Suitable materials here are glass ceramics, Zerodur, ULE or Clearceram, Cordierite or Invar etc.

While certain embodiments have been described, other embodiments are possible.

As an example, embodiments have been described in which reference bodies for encoder systems were described. However, the disclosure is not limited in this respect, and the concepts and embodiments described herein can be applied in the context of connecting bodies used in other ways.

As another example, embodiments involving microlithography have been described herein, but the disclosure is not limited in this respect. For example, the concepts and embodiments described herein can be used in connection with other optical applications or imaging methods.

As known to those skilled in the art, microlithography systems typically include the following elements and operate in the following fashion. A microlithography system typically includes a light source, an illumination system of optical elements (e.g., one or more lenses, one or more mirrors, and/or one other optical elements such as polarizer elements or gratings), a projection objective of optical elements (e.g., one or more lenses, one or more mirrors, and/or one other optical elements such as polarizer elements or gratings) and a wafer stage. The light source typically provides light of an appropriate wavelength. The illumination system typically provides, in an appropriate fashion, the light from the light source to a reticle (commonly referred to as a mask) supported by a reticle stage. The projection objective typically provides, in an appropriate fashion, the light from the reticle to a wafer supported by the wafer stage. The wafer typically includes one or more light sensitive materials at or near its surface with the overall effect being that the light that passes from the light source, through the illumination system, reticle and projection objective, and images a pattern from the reticle to the light sensitive materials(s) at or near the wafer surface.

U.S. Pat. No. 5,669,997 (Robbert et al.) and DE 197 55 482 A1 (Hangleiter et al.) are incorporated herein by reference.

Other embodiments are in the claims.

What is claimed is:

1. An Arrangement, comprising:
a first body having a first contact surface;
a second body having a second contact surface; and
a material connected to the first and second contact surfaces at a joining location,
wherein at least one surface selected from the group consisting of the first contact surface and the second contact surface is divided into a plurality of partial contact surfaces that are at least partly separated from each other; and a surface area of each of the partial contact surfaces is less than 15% of a total surface area of the joining location.

2. The arrangement according to claim 1, wherein the surface area of each of the partial contact surfaces is less than 5% of the total surface area of the joining location.

3. The arrangement according to claim 1, wherein at least a fraction of each of the partial contact surfaces is completely separated from the other partial contact surfaces.

4. The arrangement according to claim 1, wherein the partial contact surfaces are defined at least partly by depressions in the surface of the corresponding body.

5. The arrangement according to claim 1, wherein at least some of the partial contact surfaces have a contour selected from the group consisting of substantially polygonal outer contours and substantially rectangular outer contours.

6. The arrangement according to claim 1, wherein the partial contact surfaces are formed in a region of the first contact surface, and the second contact surface is substantially planar at the joining location.

7. The arrangement according to claim 1, wherein the connection between the first and contact surfaces comprises an optical contacting connection.

8. The arrangement according to claim 7, wherein the material comprises an adhesive.

9. The arrangement of claim 8, wherein at least one recess is provided in a region of at least one partial contact surface, and the adhesive is in the recess so that the adhesive contacts the first and second bodies.

10. The arrangement according to claim 9, wherein the recess comprises a channel and a through-hole leading to the partial contact surface.

11. The arrangement according to claim 1, wherein the first and second bodies are connected together by at least one layer of an additional material that between the first and second contact surfaces.

12. The arrangement according to claim 11, wherein the at least one layer of additional material substantially levels out manufacturing irregularities of the first and second contact surfaces, co-planarity deviations of the partial contact surfaces, or both.

13. The arrangement according to claim 11, wherein the material is selected from the group consisting of inorganic materials, solders, low temperature bonding materials, anodic bonding materials, and fusion bonding materials.

14. The arrangement according to claim 1, wherein the first body comprises a first material with a first coefficient of thermal expansion, the second body comprises a second material with a second coefficient of thermal expansion, and the first and second coefficients of thermal expansion are substantially the same.

15. The arrangement according to claim 14, wherein the first material and the second material are a same type of material.

16. The arrangement according to claim 1, further comprising a third body having a third contact surface, the third contact surface being connected to the first contact surface at a second joining location

17. The arrangement according to claim 16, wherein the second and third bodies are connected to and adjacent each other at third joining location.

18. The arrangement according to claim 17, further comprising a glue that glues the second and third bodies together at the third joining location.

19. The arrangement according to claim 1, wherein the first body comprises a carrier body and the second body comprises a thin, plate-shaped body.

20. The arrangement according to claim 1, wherein the first body comprises a structural component of an optical device, and the second body comprises an optical component.

21. The arrangement according to claim 19, wherein the second body comprises a reference grid for an encoder system.

22. A method, comprising:
connecting a first contact surface of a first body with a second contact surface of a second body via a material at a joining location, at least one surface selected from the group consisting of the first contact surface and the second contact surface being divided into a plurality of partial contact surfaces that are at least partly separated from each other, a surface area of each of the partial contact surfaces being less than 15% of a total surface area of the joining location.

23. The method according to claim 22, wherein the surface area of each of the partial contact surfaces is less than 5% of the total surface area of the joining location.

24. The method according to claim 22, wherein at least some of the partial contact surfaces are completely separated from one another.

25. The method according to claim 22, wherein the partial contact surfaces are defined at least partly by depressions in the corresponding contact surface.

26. The method according to claim 22, wherein at least some of the partial contact surfaces have a contour selected from the group consisting of substantially polygonal outer contours and substantially rectangular outer contours.

27. The method according to claim 22, wherein the partial contact surfaces are formed in the first contact surface, and the second contact surface is substantially planar at the joining location.

28. The method according to claim 22, wherein the first and second contact surfaces are connected together via an optical contacting connection.

29. The method according to claim 28, wherein the method includes introducing an adhesive into a recess provided in at least one of the first and second partial contact surfaces in such a way that the adhesive contacts the first and second bodies.

30. The method according to claim 28, wherein the adhesive is introduced through a channel and a through-hole in the first body and/or the second body that leads to the partial contact surface.

31. The method according to claim 22, wherein the first and second bodies are connected together via at least one layer of an additional material between the first and second contact surfaces.

32. The method according to claim 31, wherein the at least one layer of additional material substantially levels out manufacturing irregularities of the first and second contact surfaces, and co-planarity deviations of the partial contact surfaces, or both.

33. The method according to claim 31, wherein the first and second bodies are connected at the joining location via at least one material selected from the group consisting of inorganic materials, solders, low temperature bonding materials, anodic bonding materials, and fusion bonding materials.

34. The method according to claim 22, wherein the first body comprises a first material with a first coefficient of thermal expansion, the second body comprises a second material with a second coefficient of thermal expansion, and the first and second coefficients of thermal expansion are substantially the same.

35. The method according to claim 34, wherein the first and second materials are a same type of material.

36. The method according to claim 22, wherein, at a second joining location, the first contact surface is connected to a third contact surface of a third body.

37. The method according to claim 36, wherein the second body and the third body are connected and adjacent to one another in a third region joining location.

38. The method according to claim 37, wherein the second body and the third body, in the third joining location, are glued together or optically connected to one another.

39. The method according to claim 22, wherein the first body comprises a carrier body, and the second body comprises a thin, plate-shaped body.

40. The method according to claim 22, wherein the first body comprises a structural component of an optical device, and the second body comprises an optical component.

41. The method according to claim 40, wherein the second body comprises a reference grid element for an encoder system.

42. An Arrangement, comprising:
a first body having a first contact surface; and
a second body having a second contact surface, the first and second contact surfaces being connected to the first body at a joining location,
wherein a contact surface selected from the group consisting of the first contact surface and the second contact surface is divided into a plurality of partial contact surfaces that are at least partly separated from each other, and a surface area of each of the partial contact surfaces is less than 15% of a total surface area of the joining location.

43. The arrangement according to claim 42, wherein the first and second contact surfaces are connected by an optical contacting connection.

44. The arrangement according to claim 42, further comprising an adhesive, wherein at least one recess is provided in the region of at least one the first and second partial contact surfaces, the adhesive is the recess so that the adhesive contacts the first and second bodies.

45. The arrangement according to claim 43, wherein the recess is formed in at least one of the first body and the second body by one of a channel and a through-hole leading to the partial contact surface.

46. A system, comprising:
an optical device; and
the arrangement of claim 1,
wherein the system is a microlithography system.

47. A system, comprising:
an optical device; and
the arrangement of claim 1,
wherein the system is a microlithography system.
